(19) United States
(12) Patent Application Publication
(10) Pub. No.: US 2004/0249883 A1
(43) Pub. Date: Dec. 9, 2004

(54) System and method of website data transfer handshake

(76) Inventors: Venkataraman Srinivasan, Phoenix, AZ (US); Samuel Joseph Shoen, Scottsdale, AZ (US); John Anthony Kestner, Tempe, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/457,135

(22) Filed: Jun. 9, 2003

(51) Int. Cl. G06F 15/16; G06F 7/00; G06F 17/30

(52) U.S. Cl. 709/203; 709/248; 707/10

(57) ABSTRACT

A computer network uses first and second computers to host first and second websites. Customer data is accumulated at the first website. The customer data is stored in a database. The first website creates a reference number from a customer identification number and reservation number to identify a location of the customer data in the database. The customer selects a hyperlink from the first website to the second website. The reference number is sent to the second website in the URL address string. The second website uses the reference number to retrieve the customer data stored in the database and populates the second website. The second website provides information and recommendations generated from a suggestive analysis of the customer data for the benefit of the customer.

### CROSS REFERENCE TO RELATED PATENT APPLICATIONS

The present patent application is related to copending U.S. patent application Ser. No. ______, Attorney Docket No. 670744.00002, entitled “System and Method of Suggestive Analysis of Customer Data”, and filed concurrently herewith by Venkataraman Srinivasan et al.

### FIELD OF THE INVENTION

The present invention relates, in general, to data transfer to a website and, more particularly, to system and method of website data transfer handshake.

### BACKGROUND OF THE INVENTION

Many businesses provide reservation services for customers to schedule the rental or use of the goods and services offered by the business. The travel industry uses reservations to schedule airline flights, hotels, and rental cars. The moving and storage industry uses reservation services to arrange for rental and use of trucks, loading, moving, unloading, and storage. In the self-serve moving and storage business, a customer may reserve a certain size truck and any needed moving equipment and supplies for a number of days. By making a reservation, the customer can plan the move and pick up the truck on the scheduled day with reasonable certainty that everything will be ready and available.

With the wide availability of computer communications and the use of the internet many businesses make reservations available on company websites. For example, a customer needing to reserve a rental truck may visit the truck rental company website and find a user-friendly, menu-driven webpage designed to simplify the reservation process. The webpage will include descriptions and pictures of goods and services offered by the rental company, alternatives and advise to assist the customer, and pricing information all designed to make the reservation process as convenient and efficient as possible. The customer wants to get the needed rental equipment and services at a fair and competitive price and without spending too much time and enduring unnecessary complications. The rental company wants to make as many sales through its reservation system as possible for a profit. The customer makes the reservation by entering basic information such as name, address, telephone number, email address, selection of rental equipment and supplies, pick-up location and time, drop-off location and time, and credit card number.

The moving process involves many different steps and tasks that need to get done. The items to be moved must be packed in boxes, the truck must be loaded and driven to the new location, and the truck must be unloaded and boxes unpacked. In addition, there are ancillary tasks associated with the moving process. For example, the old place may need to be cleaned, the new place may need repair and yard work, and utility services such as cable, electrical, telephone lines, and gas lines may need to be connected. One business may rent trucks, another business provides moving labor, another business cleans buildings, and yet another business provides landscaping services. No single business offers all of these services.

There exist general purpose websites that provide a variety of related services under one roof. The general purpose website may be geared to the moving and storage industry, the travel industry, or any other service oriented sector with a number of sub-services. The customer visits the general purpose website and finds descriptions, alternatives, advise, and information about the featured services. The general purpose website will include hyperlinks to other websites which offer specific services. For example, the customer may visit a general purpose website oriented to the moving and storage industry that lists featured services such as load and unload help, clean-up, landscaping, and repairs. The customer may enter certain information such as name, address, origination location, destination location, length of rental, and additional services needed. The hyperlink for each featured service takes the customer to another website with a different uniform resource locator (URL) address. Clicking the hyperlink will launch the customer to the featured service website. However, any information entered in the general purpose website is not transferred to the featured service website and the customer must re-enter all relevant information. Moreover, the featured service website will have no information about the customer, nor any information about which services may be the most useful to the customer. The customer must begin again in providing information and searching for desired services. The featured web site will not be able to offer useful services, make recommendations, or be able to custom arrange or organize its website for the benefit or convenience of the customer.

The same dilemma may occur if the customer begins at specific service website, e.g. truck rental website, and then launches by hyperlink to a general purpose moving website or other specific service website for additional needed services. The customer and moving related information entered at the truck rental website is not transferred to the general purpose website or to the other specific service website. Again, the customer begins from scratch in providing information and searching for the specific services. The customer must re-enter the same information, which is inconvenient, time consuming, and may result in lost sales if the customer becomes confused or discouraged.

### SUMMARY OF THE INVENTION

In one embodiment, the present invention is a method of communicating between first and second websites, comprising accumulating data at a first website, storing the data in a database, creating a reference identifier to a location of the data in the database, linking from the first website to the second website, transferring the reference identifier to the second website, and retrieving the data stored in the database with the reference identifier transferred to the second website.

In another embodiment, the present invention is a method of accumulating data at a first website and populating a second website with data from the first website, comprising storing data accumulated from a first website into a database, transferring a reference which identifies a location of the data in the database to the second website, and retrieving the data stored in the database with the reference transferred to the second website.

In yet another embodiment, the present invention is a method of transferring data from a first website to a second website, comprising accumulating data at a first website, linking from the first website to the second website, accessing the data accumulated at the first website from the second website, and populating the second website with information derived from the data from the first website.

In yet another embodiment, the present invention is a method of populating a website with customer data, comprising storing customer data into a database, transferring a reference which identifies a location of the customer data in the database to the website, retrieving the customer data stored in the database with the reference transferred to the website, and populating the website with information derived from the customer data.

### BRIEF DESCRIPTION OF THE DRAWINGS

FIG. 1 is a block diagram of an internet-based network computer system used to host and operate websites;

FIG. 2 illustrates a first webpage on a truck rental website;

FIG. 3 illustrates a second webpage on the truck rental website;

FIG. 4 illustrates a third webpage on the truck rental website;

FIG. 5 illustrates a fourth webpage on the truck rental website;

FIG. 6 illustrates a first webpage on a moving help website;

FIG. 7 illustrates the moving help website accessing the same database associated with truck rental website;

FIG. 8 illustrates the moving help website populated with information and recommendations generated from the suggestive analysis of the customer data;

FIG. 9 illustrates the steps involved in generating recommendations using suggestive analysis of the customer data; and

FIG. 10 illustrates the steps involved in transferring data between websites.

### DETAILED DESCRIPTION OF THE DRAWINGS

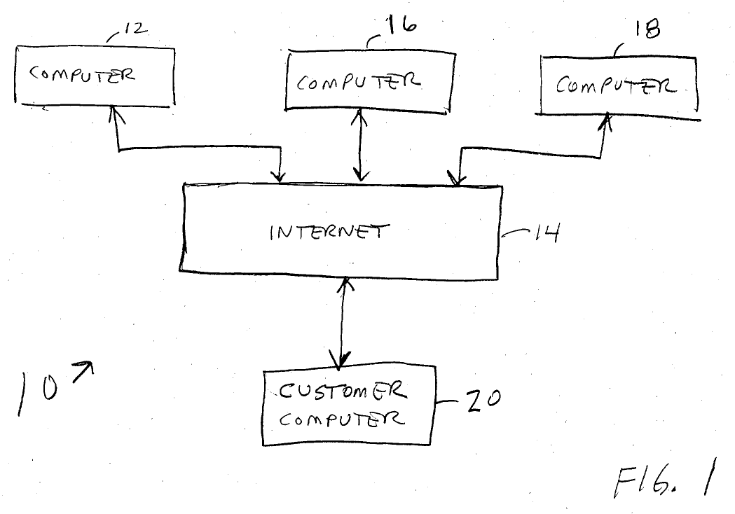

A computer network 10 is shown in FIG. 1 used to host and operate commercial websites. A first merchant or business develops and operates a first website on computer 12. Computer 12 is connected to an open architecture computer communication network 14, e.g. world wide web, also known as the internet. A second merchant or business develops and operates a second website on computer 16 which is also connected to and interacts with internet 14. A third merchant or business develops and operates a third website on computer 18 which is also connected to and interacts with internet 14. A customer uses computer 20, which is connected to and interacts with internet 14, to search, display, and utilize the websites on computers 12, 16, and 18.

The first website on computer 12 offers goods and services to customers. The customer types in the URL address of the website of interest and browses the available goods and services offered by the first merchant. If the customer wants to purchase goods and services offered by the first merchant on the website, the customer makes his/her selections and enters personal information to complete the transaction. The personal information includes name, billing address, shipping address, telephone number, email address, credit card number, and special instructions.

The organization of the website can take many forms and hierarchical structures. Some websites pack as much information and as many hyperlinks as possible into the first webpage under the theory that if the customer cannot find what he/she wants at first glance, then they will move on to another website. Other websites have a first webpage that is clean and simple and count on the customer providing some preliminary information to identify the area of interest before moving to secondary or lower level webpages.

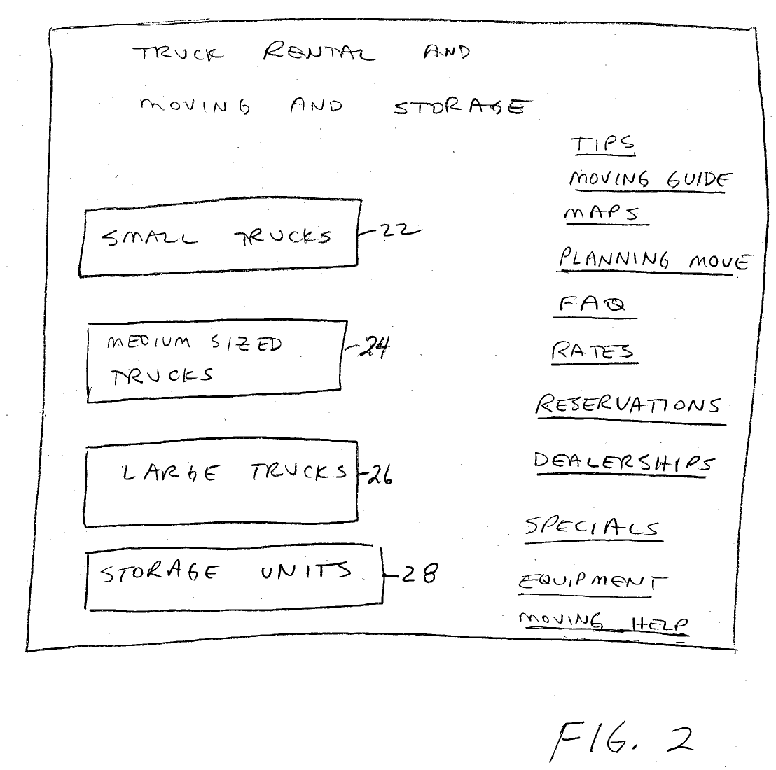

Assume as an example that the first merchant is a truck rental company and the first website offers truck rentals and moving and storage services for residential and business users. FIGS. 2-5 illustrates a simplified view of a few of the types of selections and information that can be made available on the truck rental website. An actual commercial website will include much more in the way of graphics, drawings, text, marketing, color, and appeal. The hierarchical structure of the truck rental website is organized by design choice.

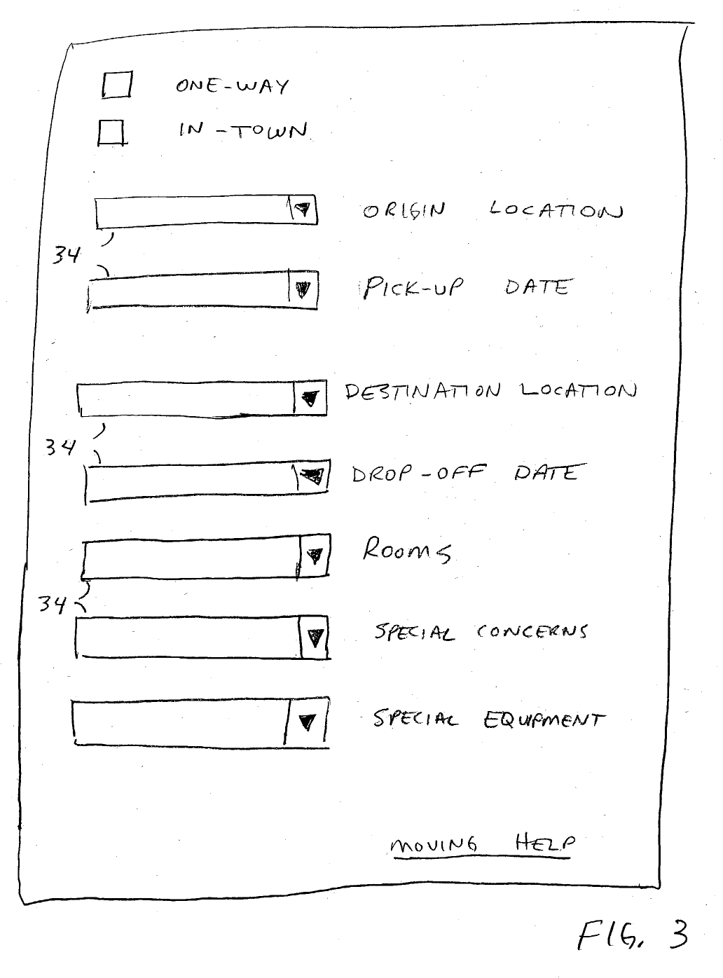

The truck rental website operates as application software or computer program running on a general purpose computer with associated microprocessor, memory, hard disk storage, and communication links such as shown in FIG. 1. The truck rental website may include a first webpage offering different size trucks, rates and reservations, and locations of dealerships such as shown in FIG. 2. The first webpage may also include other hyperlinks to moving related information, advise, recommendations, specials, and equipment guides. The customer selects between small truck 22, medium-sized truck 24, and large truck 26, or storage units 28, or explores one or more of the hyperlinks. Once the truck is selected, the customer specifies one-way, in-town, origination location, destination location, pick-up date and time, drop-off date and time, number and nature of rooms to be moved, nature and special concerns for the items being moved (heavy, fragile, safety precautions, security measures, permits required), and special or custom moving equipment needed in a second webpage as shown in FIG. 3. Drop-down menus 34 provide common choices to simplify the selection process and improve the selection data accuracy and integrity.

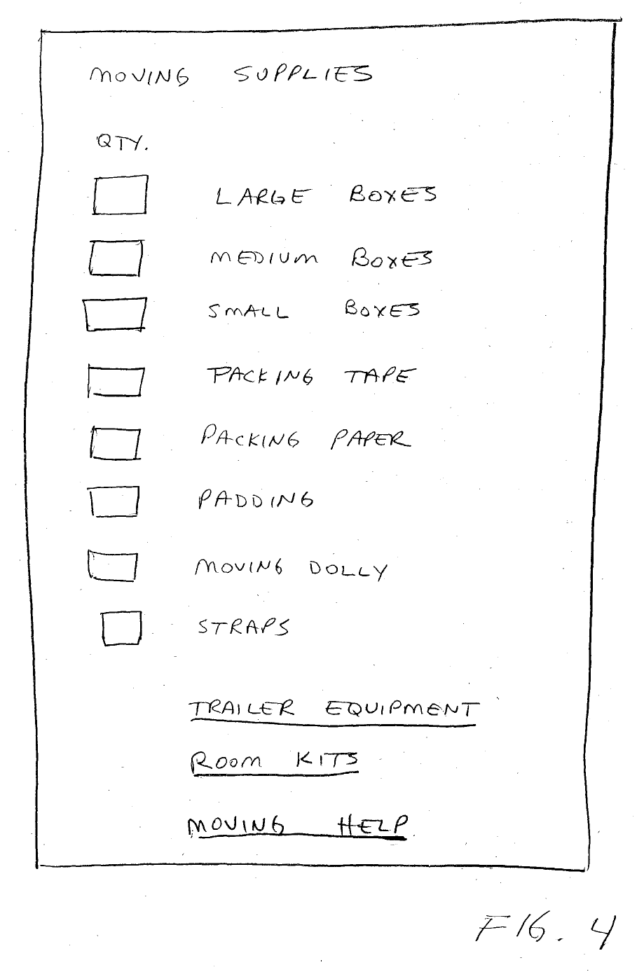

With the basic moving information, the customer is taken to another webpage which offers moving supplies such as boxes, tape, packing paper, padding, moving dollies, and straps. The moving supplies webpage as shown in FIG. 4 may include hyperlinks to trailering equipment, e.g. lights, trailer balls, and hitches, and room kits which provide standard sets of supplies for bedroom, kitchen, den, etc. The customer selects quantities of supplies and equipment to aid in the move. The customer may visit other webpages on the truck rental website to compare pricing and options, obtain recommendations and advise, and gather information to finalize his/her selections and complete the reservation.

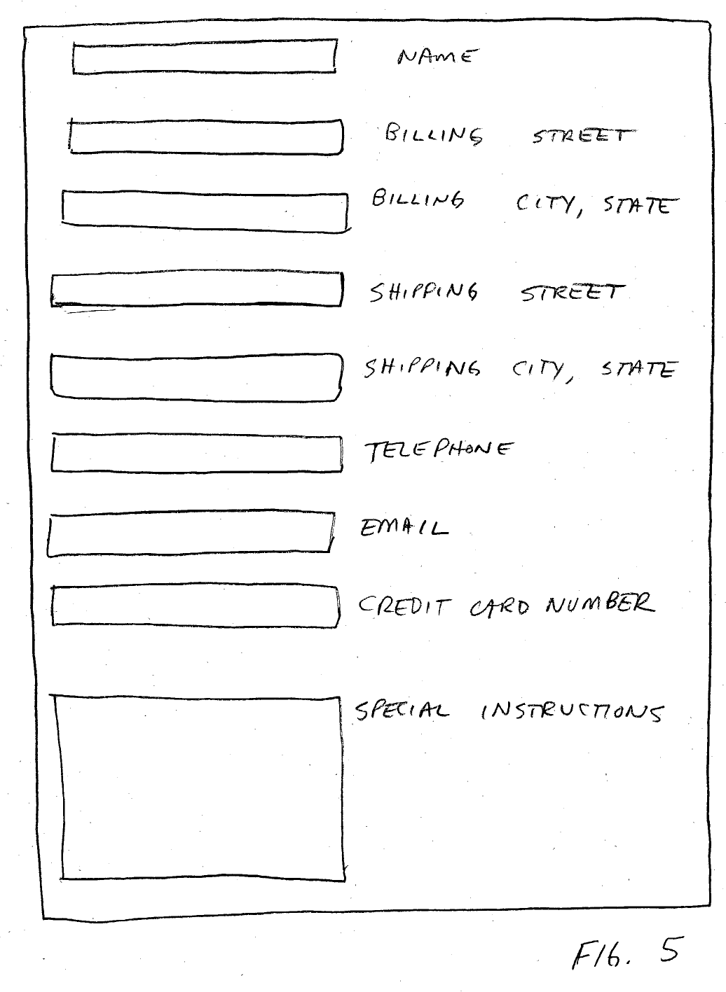

Finally, the customer arrives at the billing webpage as shown in FIG. 5 where he/she enters personal information such as name, billing address, shipping address, telephone number, email address, credit card number, and special instructions. The truck rental company webpages have collected a significant amount of information about the customer and the planned move. Some information is collected from the customer entering data and browsing through the truck rental website. Other information can come from other sources, e.g. customer datasheet or survey, customer's employer, or public information. The truck rental company knows the origination location, destination location, number and type of rooms, size of the truck, special moving equipment reserved, details about special items to be moved, and other concerns, questions, inquiries, and special instructions from the customer. The customer information and moving related information is stored as a reservation under the customer in a database on computer 12 or other computer system external to the website and controlled by the truck rental company. The credit card number is particularly sensitive information and may or may not be entered into the database depending on the truck rental company's policy toward security, privacy, and liability. The truck rental company creates a customer identification number unique for the customer, if one does not already exist, and further creates a reservation number for the selected truck rental and moving supplies and equipment which have just been selected and reserved. The customer identification number and reservation number are used as a record locator or identifier of the reservation in the database. The database record of the reservation is useful in case the customer wants to come back at some future time and change the reservation. The customer simply enters his/her customer identification number and reservation number and the truck rental website accesses the corresponding record(s) in the database and displays the customer and moving related information on the website. The customer can view the information and readily make desired changes.

The truck rental company operating the website on computer 12 is in the business of truck rental and moving and storage services. There are many other aspects to the move that the customer must consider and many different steps and tasks that need to get done. The items to be moved must be packed in boxes, the truck must be loaded and driven to the new location, and the truck must be unloaded and boxes unpacked. In addition, there are ancillary tasks associated with the moving process. For example, the old place may need to be cleaned, the new place may need repair and yard work, the customer may require childcare or eldercare during the move, and utility services such as cable, electrical, telephone lines, and gas lines may need to be connected.

The truck rental company does not offer all of these services. However, the truck rental company does provide access to moving help by the way of a hyperlink to a separate and independent moving help website. The moving help hyperlink can exist on any one or combination of webpages on the truck rental website, see FIGS. 2, 3, and 4, and establishes a link to a general purpose website that provides a variety of moving related and featured services under one roof. Selecting the moving help hyperlink causes the customer to leave the truck rental website on computer 12 and arrive at the general purpose moving help website on computer 16 operated by the second merchant. In this case, the second merchant is a moving help website host or marketplace operator. An intermediate webpage may be displayed to inform the customer that he/she is being transferred from the truck rental website to the general purpose moving help website. The transfer notice provides a clear delineation between the truck rental business and the moving help business, which are independent and separate entities and websites, to avoid customer confusion and any perceived association, affiliation, obligation, or responsibility between the website owners. The truck rental company and marketplace operator typically have a business relationship, and may even be controlled by the same corporate parent, but the general purpose moving help website has a different URL address and exists separate, distinct, and independent of the truck rental website, possibly on the same computer system 12 and possibly a different computer system 16.

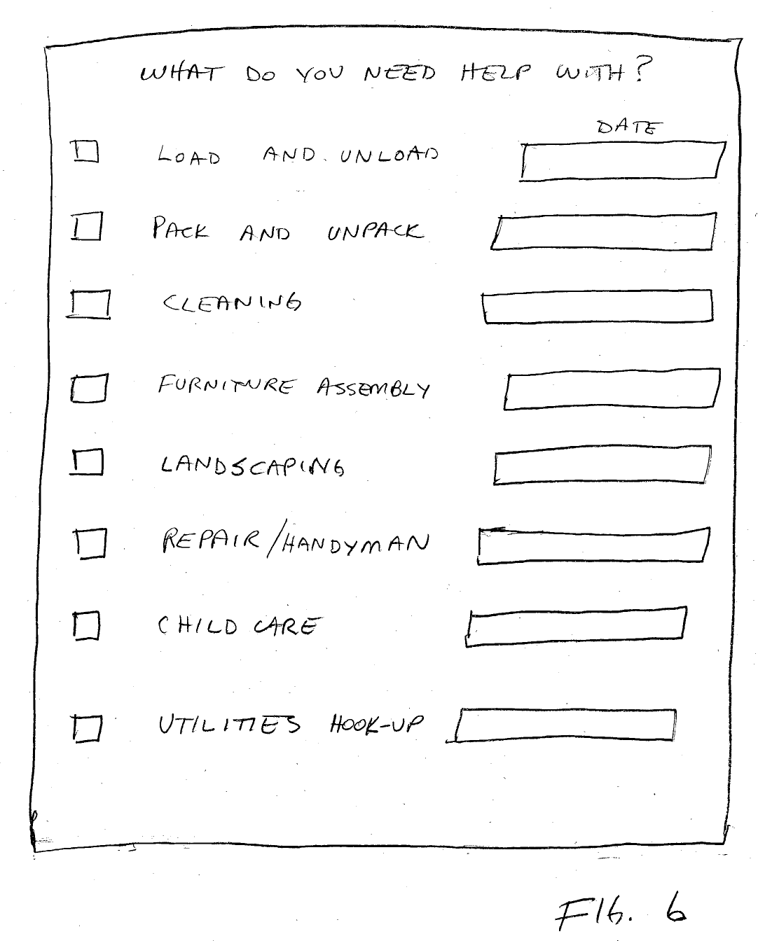

The marketplace operator administering the moving help website on computer 16 is a person, company, or organization which brings together the goods and services offered by a number of merchants and service providers to a common website or place for the benefit of the customer. The marketplace operator does not itself provide all the peripheral moving services, and in fact may not directly offer any of these moving services, which the customer may require or find useful and convenient. The moving help website such as shown in FIG. 6 is a collection of service providers and other websites each constituting separate and independent business that offers one or more of the specific moving services that the customer may need.

The customer may not know all of the services that might be available, how to get started, where to go to get the services, whether the service provider is reputable and provides quality services at competitive prices, and may not have the time, patience, and confidence to conduct the necessary research. The marketplace operator brings a large number of bona fide service providers together with useful services, established quality standards, and competitive pricing and presents the service providers to the customer in an organized manner. The customer selects the service provider(s) offering the best overall value and arranges for the work to be done. The marketplace operator acts as a liaison and intermediary between the customer and service provider to connect the right need with the right service and helps insure that all parties communicate and get what each expects. The customer wants to have multiple choices to select from, quality service, and fair price. The service provider wants to have a steady stream of work, a fair understanding of the work to be performed in order to schedule the proper resources and provide a fair and accurate quote, and to get paid upon completion of the job.

The customer is allowed to select one or more of the featured services such as load and unload labor, driving assistance, clean-up, landscaping, childcare, and repairs. The proposed job is forwarded to the actual service provider who may accept or reject the job or propose alternate conditions. The moving help website may also include hyperlinks to one or more websites that offer the featured services.

The marketplace operator provides a valuable service in that he/she has collected, compiled, and organized a group of service providers and a number of websites featuring services that are relevant and useful to the customer. The moving help website is more than just a list of service providers and collection of hyperlinks. The marketplace operator acts as an interface and liaison between the customer and the moving service provider, and as a coordinator and scheduler of the moving help services. The moving help website may provide a number of alternatives and selections for the ancillary moving services as well as advise, answers to frequently asked questions (FAQs), recommendations, customer service rating system, and secure payment mechanism. The moving help website is a convenient and valuable resource to the customer and significantly reduces the time and effort involved in entering data and planning, organizing, and executing the move.

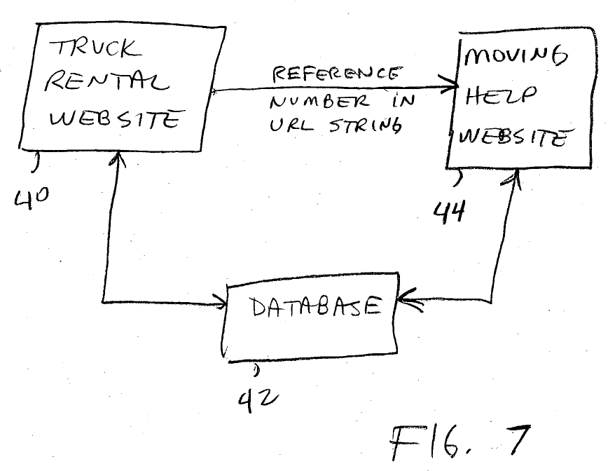

As discussed above, the customer has entered a significant amount of personal and moving related information while interacting with the truck rental website. This information is stored in a database operated and controlled by the truck rental company and accessible by customer identification number and reservation number as shown in FIG. 7. Truck rental website 40 accesses database 42 with the customer identification number and reservation number. The customer's personal and moving related information stored in the database is accessible if the customer identification number and reservation number are known in addition to the location and organization of the database and any other security or encryption codes.

Some of the convenience and benefit of using the moving help website would be lost if the customer had to re-enter all of the same information and essentially start over again. Instead, the personal and moving related information is transferred from the truck rental website to the moving help website to populate fields with customer information and pass along customer selected moving related information which can be used to provide basic information, answer initial inquiries, and even custom organize the moving help website to better service the customer's needs. By making the personal and moving related information available to the moving help website, the customer will immediately see his/her name displayed with a polite greeting. The customer will not have to re-enter billing address, shipping address, telephone number, email address, date of move, origin, destination, and other moving related information which has already been provided in the truck rental website. Moreover, the moving help website will have detailed information related to the customer and his/her specific needs right from the start of the session. The moving help website will know the size of the truck being used, number and nature of rooms to be moved, nature and special concerns for the items being moved (heavy, fragile, safety precautions, security measures, permits required), special moving equipment being reserved, quantity and type of moving supplies ordered, and even a history of recommendations, advise, FAQs, and general information sought or requested by the customer while browsing the truck rental website.

For example, with the personal and moving related information, the moving help website will be able to determine how much moving labor may be necessary and, from the size of the truck and the number and nature of rooms to be moved, be able to recommend the optimal number of workers needed and special equipment which could make the job easier, safer, and more efficient. From the nature and special concerns for the items being moved, the moving help website can list the moving helpers that are specifically equipped, qualified, experienced, bonded, and insured to handle heavy, fragile, sensitive, or unique items. If the items to be moved are potentially hazardous, the moving help website can recommend service providers equipped and trained to follow prudent safety precautions and obtain necessary permits. The moving help website can include links to government agencies, health, safety, and legal requirements and notices needed to move regulated items. If the items to be moved are particularly valuable or rare, the moving help website can arrange for a service provider that handles security and insurance. From the origin and destination information, the moving help website can arrange for a service provider that plans the optimal route and provides civil information such as road closures, weather warnings, and notices of scheduled events that could otherwise complicate or interfere with the move. If the customer spent time on the truck rental website researching FAQs and help screens on certain topics, then the moving help website could display links to other websites that specialize in those areas and might provide further information.

Using the existing customer information stored in the database has a number of uses and applications. The moving help website can perform a suggestive analysis of the customer data to generate recommendations and information of benefit and use to the customer. A suggestive analysis involves a review and evaluation of the customer data to determine what advise, insights, options, hints, recommendations, and other useful information can be provided to the customer in an organized manner to help with the moving task. As discussed above, once the truck rental website has stored the customer data in the database and the moving help website has retrieved the customer information using the reference identifier supplied by the truck rental website, the moving help website can then perform a number of calculations, estimations, and extrapolations based on the customer and moving related information retrieved from the database. The suggestive analysis process yields information and recommendation derived from the customer and moving related information which is then displayed on the moving help website for the benefit of the customer.

From the size of the truck and/or the number and type of rooms, the moving help website can estimate and recommend the number of helpers which would most efficiently accomplish the moving task. The moving help website can provide a cost benefit analysis of time to do the job versus rate per hour of various service providers by using the customer and moving related information to estimate the job and then matching the job with service provider capabilities and options. With the customer's authorization, the moving related information, or a portion thereof, is also forwarded to the service providers to better estimate special or custom jobs. Each service provider will advertise a capability and have established a track record and feedback history from other customers. For example, from prior history, the moving help website knows that a 24-foot truck takes on the average 5 man-hours to load and another 5 man-hours to unload. The moving help website can offer alternatives in that a first moving help service provider may advertise that they can load and unload a 24-foot truck in 4.3 hours for a certain rate per hour while a second moving help service provider may offer a much lower price per hour but require more hours to do the job. From the feedback history, the first moving help service provider may have a high rating in terms of completing the job as promised with high quality and customer service marks. The second moving help service provider may consistently take more time than estimated and may have a history of customer complaints or damage to the moved items.

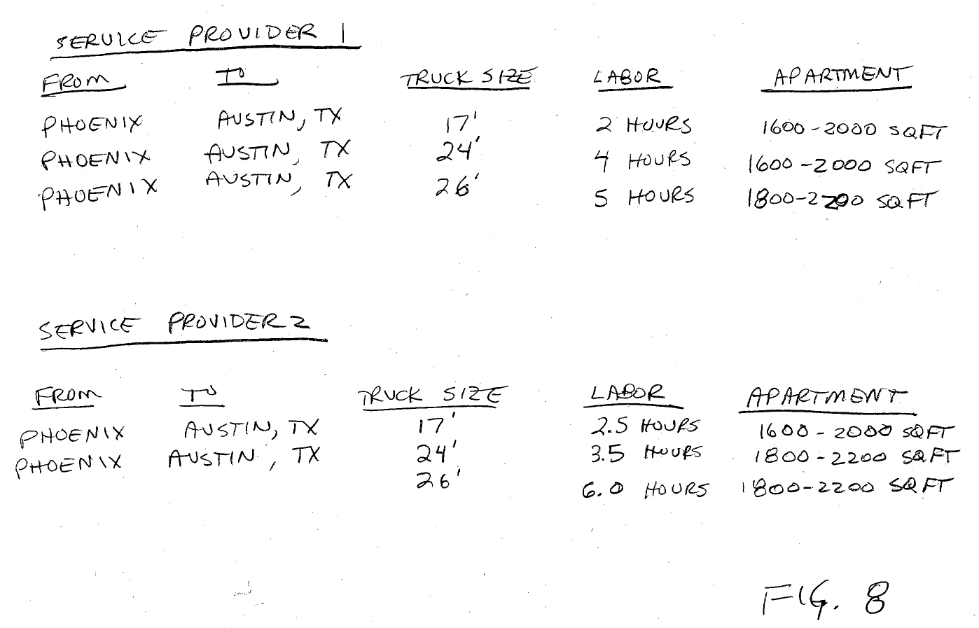

FIG. 8 illustrates the results of a suggestive analysis performed on the customer data to show estimated moving help times and apartment choices based on rental truck size. The suggestive analysis process shown in FIG. 8 used rental truck size to look-up quotes and estimates provided by various moving help service providers in the area. The suggestive analysis converted rental truck size to a probable quantity of furniture and then extrapolated the quantity of furniture to the number of square feet of apartment to fit the furniture.

Using the moving related information, the moving help website can also make suggestions to alternative truck sizes and other moving options. The moving help website could provide a chart or suggestive analysis of different truck sizes and different destinations, both in the local area and nationwide, and the moving helper hours for different service providers for each entry. In the suggestive analysis mode, the moving help website could recommend the average number of hours needed to load or unload a certain size truck. The average number of hours can be broken down by geography, e.g. New York and Phoenix may have different averages. Furthermore, the average number of hours can be broken down by service provider to determine suggestive efficiency ratings for a given service provider.

Where the customer has provided information related to the nature and special concerns for the items being moved (heavy, fragile, safety precautions, security measures, permits required), the moving help website can recommend special moving equipment and supplies and provide advisory, regulatory, and generally helpful information which the customer may not have considered or be inclined to research.

From the size of the truck and/or the number and type of rooms, the moving help website can recommend, or link the customer to another website than can recommend, houses or apartments in the destination location. The moving help website can pre-screen the available apartments and homes for floor plans that are consistent with the rooms of furniture to be moved, within a given budget and desirable neighborhood. If the customer is moving a home with 3 bedrooms, 2 bath, kitchen, living room, family room, and 2-car garage, then the customer will need a home or apartment that will fit the moved items. If the customer is only looking for temporary housing, e.g. a smaller 2-bedroom apartment until they have time to look for a home, then the moving help website will recommend the proper size storage unit which, in combination with the apartment, will fit the moved items.

The moving help website can provide the moving related information to a realtor or provide on-line realty services for the customer. The moving related information contains useful data which the realtor can utilize to make the home buying experience as pleasant and efficient as possible. The realtor will know the size and type of previous home, the demographics of prior neighbor, and possibly the basic family data. The family data will provide key indicators of the needs of the family, whether they are up-sizing or down-sizing, and their personal tastes. The realtor will be able to put together a package that is of value to the customer.

The benefit to the customer is that by entering information at the truck rental website and storing the customer information in the database, and then linking to the moving help website, retrieved the customer information from the database, and performing a suggestive analysis to generate recommendations for a practical and yet desirable apartment or house, the customer has one less task to perform in finding a quality, convenient, and affordable place to stay. The marketplace operator will have already researched the best hotels, apartments, and rental property in the destination location which are then matched to the moving related information.

The moving help website has the ability to bundle various services and packages. For example, the customer could purchase a “studio package” with a given size truck and a small amount moving help and cleaning services, or the customer could purchase a “home-owner package” with a larger truck, more moving help, cleaning services, repair and furniture assembly, all bundled in one transaction. The moving packages could be marketed as a “going away to college package” may include a small trailer with just enough room to fill a dorm room and no moving helper services at a very affordable cost. The “first new job package” may include a small truck with minimal moving helper services. The “big promotion and growing family package” may include a large truck, cleaning services, full complement of moving helpers, yard service, maid service, trip planner, and a realtor ready to greet the family upon arrival in the destination location. The “retirement package” may go back to a smaller truck and provide storage units and auctioning services or charitable pick-up to get rid of the accumulated possessions.

The moving related information is also useful to (1) estimate the time needed to clean the old place and arrange for maid services, (2) arrange for daycare for children or the elderly, (3) determine optimum route, road closures, weather, and calendar of events of locations in route, (4) reserve hotels in route, (5) suggest restaurants, gas stations, and points of interest, (6) aid a realtor in finding a new home for the customer to purchase, (7) arrange for utilities in new place, and (8) arrange for lawn and landscaping services.

The above features can generally be described as suggestive analysis of the customer data to generate recommendations and information for the benefit and use of the customer. The moving help website is able to take information received from the customer, and collected from other sources, to help the customer with the project or task at hand. The suggestive analysis uses known information about the customer and the present task to make available resources, options, solutions, and alternatives as derived from calculations, comparisons, extrapolations, estimations, and suggestions from the known information. The suggestive analysis involves an examination and evaluation of the customer data to determine what advise, insights, recommendations, and other useful information can be provided to the customer in an organized manner to help with the moving task. The calculations may involve utilizing rental truck dimensions to determine man-hours of moving help time needed to load and unload. The comparisons may involve comparing the capabilities of several service providers to determine the best fit for the customer's needs. The extrapolations may involve analyzing the number of type of rooms in the origination location to suggest an apartment or home at the destination location. The estimation may involve estimating the number of cleaning hours needed based on the moving related information. The suggestions may involve suggesting route, hotels, restaurants, gas stations, activities for the kids, and points of interest in route. The customer may not necessary find all suggestions desirable or relevant, but in many cases, the suggestions will be useful and welcomed.

While the preset embodiment has been described in terms of a moving help website, the same principals apply to many service oriented industries and other businesses. For example, the airline, hotel, and rental car company can use information collected in one situation to make suggestions of benefit to the customer. The customer may enter information related to a trip, e.g. purpose of the trip, length of stay, and number of companions, to an airline website or airline reservation agent. The customer information is stored in a database. The airline website then makes the customer information available, with customer authorization, to a general travel website or to specific hotel and rental car websites. If the purpose of the trip is business, then the travel website can use the suggestive analysis to recommend a hotel within the traveler's budget near or centrally located to the business purpose. If the purpose of the trip is vacation or combination business and pleasure, then the travel website may recommend something closer to the beach or having a golf course on the property. The travel website may utilize the suggestive analysis to recommend a full-size sedan for 3-4 business associates on a business trip or a convertible for the Florida vacation.

In the manufacturing arena, the customer may be ordering components from a first website or salesperson. The customer information is entered into the database and made available, with customer authorization, to a general manufacturing website for the benefit of the customer. Once the customer orders the components, the manufacturing website will use suggestive analysis to ascertain that the customer may need a tradesperson or temporary laborers to assemble the components. The manufacturing website may determine that certain licenses, permits, inspections, approvals, or safety measures are needed in the manufacturing process and will make recommendations of service providers that can perform those functions.

The suggestive analysis may be used to custom organize and arrange the moving help website so that the most pertinent and useful information for the customer is readily available, front and center on the webpage. The suggestive analysis can be used to customize the suggestion, options, recommendations offered to the customer. In some situations, e.g. multi-party move, the service providers will offer discounts or special incentives. The marketplace operator can pass along those savings to the customer in the right situation based on the moving related information. If the customer is willing to make certain arrangements, e.g. staying at the same hotel chain around the country, the hotel may offer special deals.

More generally, when a customer needs to perform some task or achieve some result, the customer is inclined to provide certain information at least once which is collected and saved. Suggestive analysis involves accessing the previously saved or known customer information and processing the same information to assist with additional aspects of the larger, overall task. Suggestive analysis includes recommending service providers for related jobs, advising about time allocations and pricing, and providing helpful hints and useful information about the task at hand, related sub-tasks, and ancillary tasks which the customer may not have considered, appreciated, or understood. Suggestive analysis becomes the overseer, mentor, advisor, and oracle of information for the customer about all considerations and sub-components for the task at hand, best service providers, best prices, short-cuts, pitfalls, options, answers to FAQs, and general resource to get the task done properly and, at the same time, safer, cheaper, smoother, more efficiently, and with less stressful.

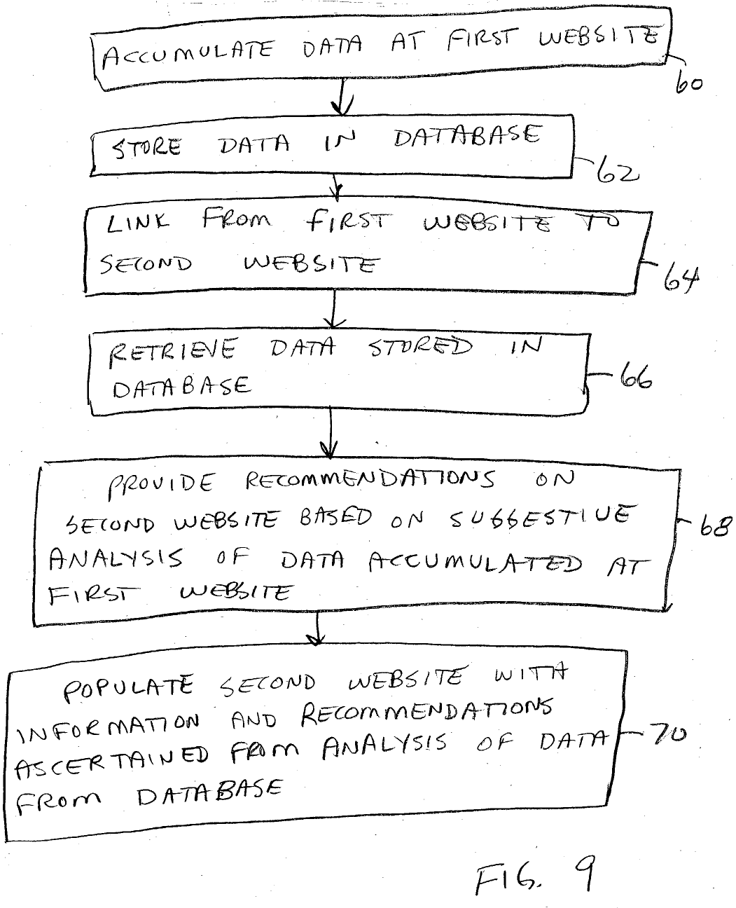

FIG. 9 illustrates the steps involved in a suggestive analysis. Step 60 accumulates data at a first website. Step 62 stores the data in a database. Step 64 links from the first website to a second website. Step 66 retrieves the data stored in the database. Step 68 provides recommendations on the second website based on suggestive analysis of the data accumulated at the first website. The related needs of the customer are ascertained and recommendations are made based on determinations of projected needs derived from the data retrieved from the database. The second website can package a plurality of related services based on the data retrieved from the database. Step 70 populates the second website with information and recommendations ascertained from the analysis of the data from the database.

The moving help website operates as application software or computer program running on a general purpose computer with associated microprocessor, memory, hard disk storage, and communication links. The moving help website is capable of receiving, parsing, accessing, and analyzing data and then making calculations, recommendations, decisions, and determinations and issuing notices and warnings based on that data. With the personal and moving related information from the truck rental website, the moving help website can provide options, recommendations, advise, notices, resources, and any other information that could be useful to the customer. If the customer and moving related information entered at the truck rental website is not transferred to the general purpose moving help website, the customer may not be inclined to provide the same information again and may not know or see the benefits that the moving help website could offer. Requiring the customer re-enter the same information, even if only name and address is inconvenient, time consuming, and may result in lost sales if the customer becomes impatient, confused, or discouraged.

The process of transferring the customer's personal and moving related information from the truck rental website or database to the moving help website has several alternate embodiments, options, and variations. Although the process can take a number of forms, in general, there is an electronic website data transfer handshake where the customer information is transferred, directly or indirectly, and made available to the moving help website.

In one embodiment, a reference number that identifies a specific external location of the data is electronically passed or made available to the moving help website. For instance, the customer identification number and reservation number together constitute the reference number identifier or locator and can be included within the URL address string when launching the moving help website from the truck rental website. The reference number comprising the customer identification number and reservation number are appended to the URL address string. An example of the URL string could be “xxx” and is generally limited to 256 characters. FIG. 7 illustrates truck rental website 40 passing the reference number to moving help website 44 in the URL address string. The moving help website parses the URL string and retrieves the customer identification number and the reservation number. Recall that the truck rental company operating the truck rental website stored the personal and moving related information in its truck rental database referenced by the customer identification number and reservation number. The database also has general password protection. With the business relationship and agreement between the truck rental company and marketplace operator, the marketplace operator operating the moving help website will know the location, password, and organization of the truck rental company database. If the data in the truck rental database is encrypted, then the moving help website will have the encryption key. The database location, password, and organization will be coded in the script and software associated with the moving help website. The marketplace operator will be able to use the customer identification number and the reservation number to access and extract the customer's personal and moving related information from the truck rental database.

Using the customer identification number and the reservation number, the moving help website downloads the customer and moving related information from the truck rental database. FIG. 7 illustrates moving help website 44 accessing database 42 with the reference number sent in the URL address string. The moving help website uses the customer information retrieved from the truck rental database to populate fields its own website, offer useful services in descending order of relevance, calculate potential needs, make recommendations, provide notices, and generally simplify the customer's task at hand. Not only will the customer have been saved the burden and inconvenience of re-entering the same or similar information into the moving help website that he/she has already provided to the truck rental website, but the moving help website will be able to use the customer's personal and moving related information to generate custom, intelligent, relevant, and efficient webpages for the customer.

Transferring the customer identification number and reservation number through the URL address string offers several advantages. The reservation number means nothing without the customer identification number. Both are needed to access the truck rental database. Therefore, another customer which receives or has access to a valid reservation number cannot purposefully alter a digital or two and see what other customer reservation pops up. The altered reservation number although valid is of no use without the corresponding customer identification number associated with that reservation number, which would not be available. Even if a hacker intercepts the URL with the customer identification number and reservation number embedded with the address string, the reference numbers are of no use without knowledge of the location and general passwords needed to enter the truck rental database and further knowledge of the organization of the database. The database address location and general password can be changed on regular basis to add security. The data in the truck rental database can be encrypted to further thwart the more persistent hackers.

As a variation to the moving help website accessing the truck rental database with a reference number supplied by the truck rental website, the moving help website may maintain is own database which is a mirror image of the truck rental database. By agreement between the truck rental company and marketplace operator, the moving help database is regularly updated to coincide with the truck rental database. The moving help website would then access its own database by any lookup mechanism it chooses, including the reference number(s) provided by the truck rental database.

Another option for transferring the customer's personal and moving related information from the truck rental website to the moving help website is to pass the information directly in the URL string. Although many communication networks are limited in the number of characters or amount of data that can be passed from one website to another, the data could be compressed using well-known compression algorithms or encoded for a more efficient data transfer. A series of characters and numbers could be encoded to have pre-defined meanings.

In yet another embodiment, the customer's personal and moving related information is sent by alternate electronic communication link between the truck rental website and the moving help website, or between the truck rental database and the moving help database, or between computer 12 and computer 16 and then relayed to the software running the websites. Computer 12 and computer 16 may have a direct communication link or indirect communication link through some network other than the internet.

There are other methods of getting the customer and moving related information into the truck rental database. Instead of entering his or her information into the truck rental website, the customer may call the truck rental company by telephone and provide the same information to a reservation agent or operator. The reservation agents enters the customer related information into the database and assigned or records the reference identifier. The reference identifier is then sent to or made available to customer for use with the moving help website. For example, the reservation agent may have the customer make a note of the reference identifier for later use on the moving help website. The reference number could be sent to the customer by electronic email. Alternatively, the reservation agent may have the customer go to the moving help website and enter the reservation number while the reservation agent is still on the telephone line. The reference number allows the customer to retrieve the pertinent customer and moving related information from the database and simplify the interaction with the moving help website.

In still yet another embodiment, the customer's computer has an unique identification number associated with the microprocessor and installed equipment. The moving help website may read with computer number or the customer may enter the computer number directly into the moving help website, which then accesses the database based on that identification. Again, the customer and moving related information is retrieved from the database and used to populate the moving help website.

Since the moving help website has access to the truck rental database, another feature is the ability to add, delete, or change the customer and moving related information in the database. The moving services selected in the moving help website is valuable information that can be added to the database. The customer may correct or change previously entered information such as correction to billing address, changing date of move, or specifying a different credit card number. With the customer approval, the information updates are reflected in all related records in the truck rental database. Otherwise, the moving help website will flag the customer that there is a discrepancy between the truck rental database and the moving help website.

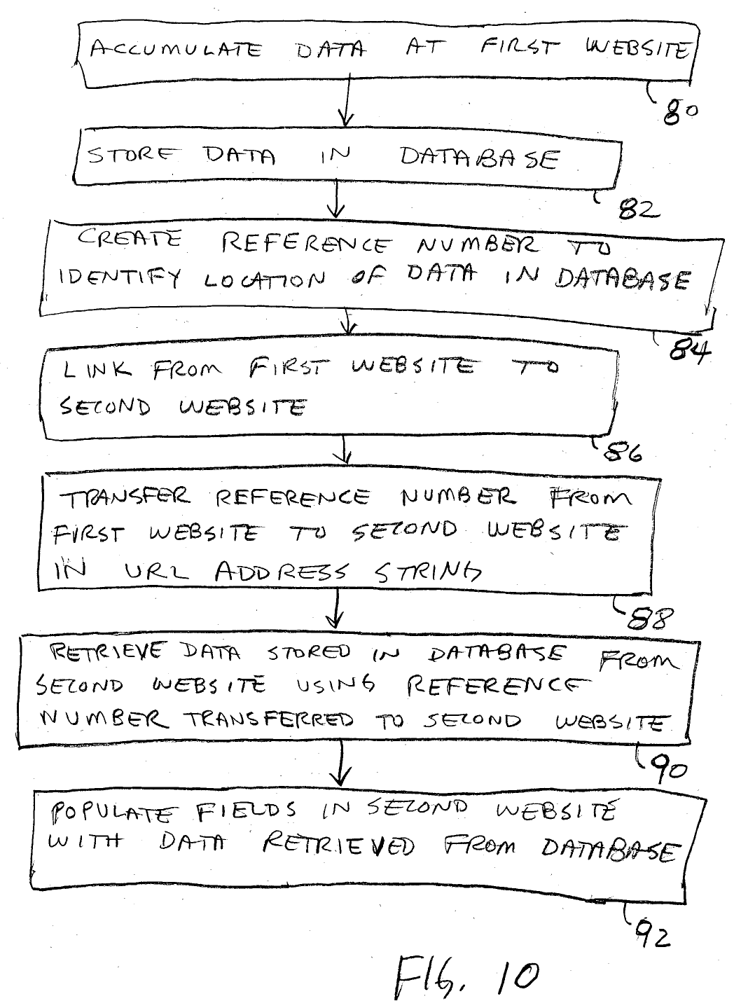

The process of transferring data from one website to another website is described in the flowchart shown in FIG. 10. Step 80 accumulates data at a first website. The data is accumulated by a customer making a reservation at the first website. The data may be entered by a reservation agent talking to the customer by telephone, email, or other electronic communication. Step 82 stores data in a database which is external to the first website. Step 84 creates a reference number identifier to a location of the data in the database. The reference identifier comprises a customer identification number and a reservation number. Step 86 links from the first website to the second website. The customer selects a hyperlink of the second website while browsing the first website. Step 88 transfers the reference identifier to the second website. Step 90 retrieves the data stored in the database from the second website with the reference identifier transferred to the second website. The reference identifier is transferred from the first website to the second website by appending the reference identifier-to the URL address string. Step 92 populates fields in the second website with the data retrieved from the database.

The marketplace operator that operates the general purpose moving help website does not provide the featured services. Some moving service providers appearing on the moving help website do not have individual websites and therefore communicate with the marketplace operator by email, telephone, or facsimile. When the customer schedules moving services on the moving help website, the selected service provider will receive an email or other communication of the proposed job. The service provider will accept or reject the job or propose alternate conditions. For example, the service provider may not be able to provide two workers on the next Monday, but they could provide one worker on that Monday and one worker on Tuesday or two workers on Wednesday. The customer will have the option of accepting or rejecting the proposed revised schedule. The marketplace operator handles scheduling and coordination between the customer and the service provider.

The selected service provider may operate a website on computer 18. The customer can switch from the moving help website to the selected service provider website by activating a hyperlink. The service provider website will provide additional information about its featured services. For example, the service provider website may be geared toward loading and unloading services.

The same process of transferring data between websites is also available to send the customer and moving related information to the service provider website on computer 18. The service provider website on computer 18 operates as application software or computer program running on a general purpose computer with associated microprocessor, memory, hard disk storage, and communication links. The service provider website is capable of receiving, parsing, accessing, and analyzing data and then making calculations, recommendations, decisions, and determinations and issuing notices and warnings based on that data.

The customer identification number and reservation number are included in the URL address string. The customer identification number and reservation number constitute a reference number that is used to access data stored in an external location. The service provider website parses the URL string and retrieves the customer identification number and the reservation number. With a business relationship and agreement between the truck rental company and service provider, the service provider operating the service provider website will know the location, password, and organization of the truck rental company database. If the data in the truck rental database is encrypted, then the service provider website will have the encryption key. The database location, password, and organization will be coded in the script and software associated with the service provider website. The service provider will be able to use the customer identification number and the reservation number to access and extract the customer's personal and moving related information from the truck rental database. Using the customer identification number and the reservation number, the service provider website downloads the customer and moving related information from the truck rental database. The service provider website uses the customer information retrieved from the truck rental database to populate fields its own website, offer useful services in descending order of relevance, calculate potential needs, make recommendations, provide notices, and generally simplify the customer's task at hand.

An integrated, user-friendly, efficient, and seamless transition from specific services is provided which the customer may first consider to other equally important yet less obvious corollary services, which may not come to mind at first or at all or at least secondarily, offered by separate and independent websites by other businesses. The truck rental website is an obvious place to start when planning a move. When the average person considers moving, one of the first needs to come to mind is a moving truck. In today's competitive marketplace, customer service is paramount. The truck rental company operating the website can gain an advantage over its competition if it can not only provide the truck and moving supplies, but further make recommendations from suggestive analysis of customer data and direct the customer to other websites that provide general purpose moving help or specific moving services. The customer experiences the benefit of virtual one-stop shopping. The moving experts involved in designing the websites will have conferred their experience and expertise into providing advise, options, recommendation, and information as to all the plans, considerations, and pitfalls involved in moving. The customer will be able to match their needs with valuable information and available service providers all within a given budget.

If the truck rental company is successful in making the reservation with the customer, then the customer and moving related information is passed along to the general purpose moving help website or specific moving service provider. The data is typically made available by passing a reference number which identifies the location of the information in the truck rental company database. The moving help website or service provider uses the reference number to access the customer and moving related information from the database and then initializes their own website the same information for the benefit of the customer. The customer benefits by avoiding the need to re-enter the same or similar data and further allows the websites to present information which is relevant and useful to the customer.

The website data transfer handshake works equally well when the first website where the data is collected is the general purpose website and the second website where the data is transferred to the specific service provider website.

Although the present invention has been described in terms of a moving and storage oriented website, the website data transfer handshake is application to other products and services. Any industry that relies upon reservations and the use of multiple service providers, such as the travel industry, is contemplated within the scope of the present invention. Moreover, any application that could benefit from transferring data from one website to a separate and independent website is contemplated within the scope of the present invention.

The present invention has been described with respect to preferred embodiment(s). Any person skilled in the art will recognize that changes be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the following claims.

What is claimed is:

1. A method of communicating between first and second websites, comprising:
accumulating data at a first website;
storing the data in a database;
creating a reference identifier to a location of the data in the database;
linking from the first website to the second website;
transferring the reference identifier to the second website; and
retrieving the data stored in the database with the reference identifier transferred to the second website.

2. The method of claim 1 wherein the data is accumulated by a customer making a reservation at the first website.

3. The method of claim 1 wherein the reference identifier comprises a customer identification number and a reservation number.

4. The method of claim 1 wherein the data is transferred from the first website to the database located external to the first website.

5. The method of claim 1 wherein the step of linking from a first website to a second website includes a customer selecting a hyperlink of the second website from the first website.

6. The method of claim 1 wherein the reference identifier is transferred from the first website to the second website by appending the reference identifier to a uniform resource locator address string.

7. The method of claim 1 wherein the data retrieved from the database is used to populate fields in the second website.

8. The method of claim 1 wherein the first website is a truck rental website.

9. The method of claim 1 wherein the second website is a moving help website.

10. A method of accumulating data at a first website and populating a second website with data from the first website, comprising:
storing data accumulated from a first website into a database;
transferring a reference which identifies a location of the data in the database to the second website; and
retrieving the data stored in the database with the reference transferred to the second website.

11. The method of claim 10 further including:
accumulating the data by a customer entering information to make a reservation at the first website;
creating a reference to the location of the data in the database from a customer identification number and a reservation number; and
linking from a first website to a second website selected by the customer.

12. The method of claim 10 wherein the reference is transferred from the first website to the second website by appending the reference to a uniform resource locator address string.

13. The method of claim 10 wherein the data retrieved from the database is used to populate fields in the second website.

14. The method of claim 10 wherein the first website is a truck rental website.

15. The method of claim 10 wherein the second website is a moving help website.

16. A method of transferring data from a first website to a second website, comprising:
accumulating data at a first website;
linking from the first website to the second website;
accessing the data accumulated at the first website from the second website; and
populating the second website with information derived from the data from the first website.

17. The method of claim 16 wherein the data is accumulated by a customer entering information to make a reservation at the first website.

18. The method of claim 16 further including:
storing the data in a database;
creating a reference identifier to a location of the data in the database;
transferring the reference identifier to the second website; and
retrieving the data stored in the database from the second website with the reference identifier transferred to the second website.

19. The method of claim 18 wherein the reference identifier comprises a customer identification number and a reservation number.

20. The method of claim 18 wherein the reference identifier is transferred from the first website to the second website by appending the reference identifier to a uniform resource locator address string.

21. A computer system for transferring data between first and second websites, comprising:
means for storing customer data into a database;
means for transferring a reference which identifies a location of the customer data in the database to the website;
means for retrieving the customer data stored in the database with the reference transferred to the website; and
means for populating the website with information derived from the customer data.

22. The computer system of claim 21 further including:
means for accumulating the data by a customer providing information to make a reservation;
means for creating a reference to the location of the data in the database from a customer identification number and a reservation number; and
means for linking to the website selected by the customer.

23. The computer system of claim 21 further including means for transferring the reference identifier from the first website to the second website by appending the reference identifier to a uniform resource locator address string.

24. A method of populating a website with customer data, comprising:
storing customer data into a database;
transferring a reference which identifies a location of the customer data in the database to the website;
retrieving the customer data stored in the database with the reference transferred to the website; and
populating the website with information derived from the customer data.

25. The method of claim 24 further including:
accumulating the data by a customer providing information to make a reservation;
creating a reference to the location of the data in the database from a customer identification number and a reservation number; and
linking to the website selected by the customer.

26. The method of claim 24 further including:
generating the reference at a first website;
appending the reference identifier to a uniform resource locator address string which links the first website to a second website; and
transferring the reference to the second website in the uniform resource locator address string.
